(19) United States
(12) Patent Application Publication
(10) Pub. No.: US 2022/0320719 A1
(43) Pub. Date: Oct. 6, 2022

(54) AERODYNE WITH ANTENNA AND ASSOCIATED ARRANGEMENT METHOD

(71) Applicants: AIRBUS DEFENCE AND SPACE SAS, Toulose Cedex 4 (FR); AIRBUS SAS, Blagnac (FR)

(72) Inventors: Thibault MAISONNAT, Toulouse Cedex 4 (FR); Eric PEYRUCAIN, Toulouse Cedex 4 (FR); Alain LAGARRIGUE, Toulouse Cedex 4 (FR); Valery GINEST, Toulouse Cedex 4 (FR)

(21) Appl. No.: 17/628,108

(22) PCT Filed: Jul. 10, 2020
(86) PCT No.: PCT/EP2020/069643

§ 371 Date: Jan. 18, 2022

(30) Foreign Application Priority Data
Jul. 19, 2019 (FR) FR1908260

(51) Int. Cl. H01Q 1/28; H01Q 21/06; H01Q 21/28

(52) U.S. Cl. CPC H01Q 1/287; H01Q 21/065; H01Q 21/28

(57) ABSTRACT

A method for arranging a set of antennas capable of transmitting or receiving in a radio frequency range in an existing aerodyne implemented either during an initial installation operation, or in a subsequent maintenance or update operation is disclosed. The method includes removing at least one component of a structural element external to the bearing surface of the existing aerodyne, the component being substantially transparent to the radio frequency range; installing the set of antennas in a zone exposed by the removal in the step; fitting an electronic and electrical harness connecting the set of antennas to a radio communications system and to a power supply inside the fuselage; re-forming the external structural element in such a way as to cover the installed set of antennas.

### TECHNICAL FIELD

The present invention relates to an aerodyne comprising one or more antenna(s), as well as an outer structural assembly and a corresponding arrangement method. In particular, it applies to fixed-wing aerodynes, such as aircrafts or gliders.

### PRIOR ART

The presence of antennas in aerodynes appears to be necessary or useful for multiple communications functions, including the acquisition of information required for the proper progress of the flight and the transmission of data relating to the covered course. Among these functions, aircraft connectivity could also provide an Internet connection, in particular by WiFi (standing for “Wireless Fidelity”), to passengers and to the crew.

An important aspect relating to antennas consists in their positioning. In particular, it is known to arrange radome systems in the upper part of the aerodyne, on the fuselage. However, such arrangements have the drawback of increasing the drag of the aerodyne, and therefore fuel consumption. In addition, substantial mechanical and aerodynamic tune-ups are required, at the cost of investment in time and budget. Typically, several days are thus necessary to install an antenna according to these solutions, relying on a highly qualified workforce. In addition, a flight authorisation is acquired only subject to satisfactory analyses and tests. The maintenance of corresponding antennas, becoming frequently necessary by difficult navigation environments (vibrations, temperature, mechanical stresses, etc.), also requires a long downtime of the aerodynes, thus increasing the cost price over time.

It is also known to arrange a radar in an aerodyne nose cone, serving as a radome, in order to detect objects or weather conditions. However, such a system provides information limited to a front view, and is not suitable, for example, for communications with satellites or terrestrial relays.

Other proposed embodiments are based on coupling antennas with aircraft wings. Thus, the patent application GB-2169866 A (inventor: RS Fitzpatrick) discloses a radome capsule retractably fastened under an aircraft wing and accommodating a mode S radar. However, such an embodiment implements mechanisms that require installations requiring time and accuracy, and relatively frequent maintenance. In addition, in the deployed mode, it affects the aerodynamics of the aircraft. What is more, its positioning makes it especially effective for communications with terrestrial antennas, but not very suitable for satellite communications.

In turn, the patent application CN 103887605 (inventors Zhou Jinzhu et al.) describes an aircraft wing incorporating antenna arrays. More specifically, the wing includes a central structure bordered by an upper coverage and a lower coverage defining its outer surfaces, each of these coverages including a central radio frequency circuit layer surrounded by heat-insulating honeycomb layers and by top and bottom panels. The central layer includes an antenna array.

This implementation of a wing with an integrated antenna makes possible both a reduction in weight and a preservation of the aerodynamic performance of the aircraft that is equipped with it. However, it has the drawbacks of restrictive requirements on the antenna positioning, closely related to the configuration of the wing, and a high exposure to external stresses.

### SUMMARY

In particular, an object of the present description is to overcome the aforementioned difficulties and drawbacks with the existing antenna systems for aerodynes.

Its potential fields of application extend to satellite communications, but also to terrestrial networks, and could offer various emission and/or reception possibilities, in particular for leisure-oriented connectivity purposes.

In particular embodiments, the invention allows for a quick and simplified installation, an economic implementation, a reduced maintenance, a preservation of the aerodynamic properties of the aerodyne and/or a good reliability of communications by radio waves.

To this end, an object of the description is an aerodyne comprising a fuselage and at least one outer structural element with an airfoil surface mounted to the fuselage and configured to confer aerodynamic properties to the aerodyne. This outer structural element comprises at least one outer shell and is provided with at least one antenna.

According to the description, the antenna(s) is/are arranged inside the outer structural element while being structurally dissociated from the outer shell(s). In addition, at least one portion of these outer shells is substantially transparent to at least one range of radio frequencies, so that the antenna(s) could perform an operation selected from at least a reception and an emission of radio waves through this(these) portion(s) of the outer shell(s).

In particular, such an outer structural element with an airfoil surface may consist of a wing or of a tail part—for the latter, the airfoil surface manifests itself in a substantial manner in the event of a disturbance of balance with regard to a stable cruise flight, and has a low or negligible impact otherwise. Thus, it could in particular consist of a dorsal fin also called vertical stabiliser (yaw stabilisation) or a horizontal stabiliser (pitch stabilisation).

Advantageously, the outer structural element corresponds to a fixed portion of the aerodyne, which allows facilitating antennas orientation stability. Hence, the aerodyne is advantageously a fixed-wing one. However, the outer structural element may also consist of a fixed portion of a rotary-wing aerodyne, such as for example a tail or possibly a fixed wing of a helicopter.

By “outer structural element with an airfoil surface”, it should be understood a structural set forming an aerodynamic unit, regardless of the composition or the multiplicity of the elements that form it. For example, such a structural element could possibly include a vertical tail fin comprising a main structure, as well as lower, longitudinal and upper cowls of this main structure.

The outer shell (or the outer shells) define(s) at least one portion of the contours of the structural element, i.e. its interface with the space surrounding the aerodyne, in particular with the ambient atmosphere. Thus, by “outer shell”, it should be understood the peripheral portion of this structural element, delimited on the one hand by an outer surface interfacing the outer structural element with the space surrounding the aerodyne, and on the other hand by an inner surface substantially parallel to the outer surface and close to this outer surface. By “close”, it should be understood a distance between the outer and inner surfaces (called thickness of the shell) is small compared to the surface dimensions, and for example less than 15% of the two surface dimensions of the outer surface, and in particular embodiments less than 10%, 5% and 2% of these surface dimensions. The outer shell may have common structural properties along its thickness, to the extent that independently in particular of stress, deformation or temperature gradients along the thickness (variations in mechanical or thermal properties), movements or inclinations of the outer surface substantially correspond to corresponding movements or inclinations of the inner surface and of the entirety of the intermediate portion. By antenna “structurally dissociated” from the outer shell, it should be understood that the antenna arranged inside the outer structural element is associated with a structure distinct from the outer shell, without being united integrally with the outer shell, for example by incorporation or joining. Thus, the antenna consists of a separate and standalone structure with respect to this outer shell. Advantageously, it could in particular be moved away from and/or inclined relative to the latter, at least for installation and maintenance thereof.

In contrast, in an aircraft wing such as that one disclosed in the patent application CN 103887605, the antenna array forms with the honeycomb layers and the lower and upper panels that border it a single structure of a composite outer shell forming the upper coverage or the lower coverage, and are inseparably linked structurally. In particular, modifications of the curvature of one of the panels or of one of the honeycomb layers affect the shape, the positioning and the orientation of the antenna array sandwiched between the honeycomb layers and the panels.

The configuration of the present description could be particularly advantageous, since it enables a positioning and an orientation of the antenna disconnected from the contours of the outer structural element. This potentially offers great flexibility of implementation, which could prove to be invaluable in ensuring good radio connectivity, in particular with satellites.

This configuration may also offer the advantage of allowing for a better protection of the antenna from external loads, related for example to difficult atmospheric conditions, to large temperature differences, or to shocks or micro-impacts.

What is more, the structural dissociation of the antenna and the outer shell could considerably facilitate the set-up and maintenance operations. The arrangement of antennas within an outer structural element with an airfoil surface and with a structural dissociation from the outer shell could seem to be surprising to a person skilled in the art. Indeed, it goes against the apparently antagonistic requirements of good aerodynamic behaviour of the airfoil and of efficient transmission of radio waves. In fact, the outer structural elements with an airfoil surface generally include portions that disturb the circulation of waves, in particular metallic ones, so that the only feasible solutions for associating them with antennas could consist in an external positioning or an integration at the surface—at the cost of the aforementioned drawbacks.

Yet, a remarkable feature of the aerodyne of the description is that at least one portion of the outer shells is substantially transparent to at least one range of radio frequencies, so that the antennas could receive and/or emit radio waves through this(these) portion(s) of the outer shells.

Thus, it is possible, in particular embodiments, to preserve the aerodynamic qualities of the aerodyne, which are often the subject of complex and costly tune-up, while benefiting from high emission and reception efficiency of the antennas, including in directional terms. By preserving the aerodynamic qualities, it is in particular possible to limit the impact of drag and thus reduce fuel consumption. By arranging the antennas inside the outer structural element with an airfoil surface, the antennas could also possibly be protected from disturbances due to existing electrical equipment.

The portions of the outer shells concerned by the substantial transparency may be made of materials suitable for this purpose, integral with other portions, for example metallic, within the outer structural element. For example, this may consist of a hood or a wing or a tail fin.

The radio frequency range(s) to which the portions of the outer shells are substantially transparent include(s) in some embodiments at least one amongst the Ku (typically between 12 and 18 GHz) and Ka (typically between 26.5 and 40 GHz) bands.

In other embodiments, which may be combined with the previous ones for the same or other portions, the radio frequency range(s) to which the portions of the outer shells are substantially transparent include at least one cellular network frequency band, for example used for communications in 4G or 5G technology.

Different means for accessing the antennas arranged inside the outer structural element, in particular for maintenance or upgrade operations, may be provided. In some embodiments, the outer structural element is removably mounted to the fuselage. In other embodiments, one or more portion(s) of the outer structural element are removable, and the antennas are accessible by removing this(these) portion(s). In some variants, hatches or flaps for accessing the antennas are provided in the outer structural element.

In advantageous embodiments, the outer structural element comprises at least one free space between the antenna(s) and the outer shell(s).

In particular, such a free space could be used to flexibly adjust the positioning or the orientation of the antennas, during the set-up of the latter or during maintenance operations.

In particular configurations:

at least one of the antennas is separated from the internal surface of the outer shell by at least 3 times the thickness of the outer shell, and in more specific embodiments, by at least 5 times, at least 10 times or at least 20 times this thickness;

at least one of the antennas is separated from the inner surface of the outer shell by at least 5 cm, and in more specific embodiments, at least 10 cm, at least 15 cm or at least 20 cm;

at least one of the antennas has an inclination which differs by at least 10° from an inclination of the inner surface the closest to the outer shell, and in more specific embodiments, at least 15°, at least 20° or at least 30°; the inclination of the inner surface is defined by a perpendicular to this surface, and the inclination of the antenna by the main line of sight of the antenna, or if the antenna is flat, by a perpendicular to the plane of this antenna.

According to particular embodiments, the aerodyne comprises at least one support structure carrying the antenna(s), this(these) support structure(s) being arranged inside the outer structural element while being structurally dissociated from the outer shell(s).

In particular, such a support structure may be fastened to the fuselage, for example by gluing.

According to particular embodiments, the aerodyne comprises at least one modem cooperating with the antenna(s) and arranged inside the outer structural element.

The modem(s) and the antenna(s) could then be integrated on at least the same board. In one variant, the modem is arranged aside opposite the antenna with which it cooperates, and could be used in a centralised manner for several antennas positioned at distinct locations and, where appropriate, with different orientations.

In some embodiments, the aerodyne having a horizontal plane (which could be defined for example as a plane perpendicular to a vertical plane of symmetry with respect to the wings), the considered antenna is oriented with an angle of inclination comprised between 45° and 70° with respect to this horizontal plane, and in particular implementations between 67° and 68°, and still more specifically between 67.4° and 67.6°.

By angle of inclination of the antenna, it should be understood the angle between a reference line of sight of the antenna and the vertical (a 0° angle therefore corresponding to a horizontal positioning of a flat antenna).

In some embodiments, the antennas are at least two in number and the aerodyne comprises one or more multiplexer(s) configured to multiplex signals respectively obtained from these antennas.

In some modes, the antenna(s) include(s) at least one transmission antenna and at least one reception antenna, these transmission and reception antennas being arranged on the same board and being spaced apart so as to avoid full duplex cross-interferences.

In advantageous embodiments, at least one of the antennas is an antenna array, the latter possibly being in particular a phase-controlled one. In particular embodiments, which may be combined with the previous ones, at least one of the antennas is a flat antenna.

In advantageous embodiments, the antenna(s) is/are electronically steerable. The absence of a rotating mechanical part for the antennas makes it possible to reduce the risk of breakdowns and the needs for maintenance.

In a first type of antenna positioning selection, the outer structural element is a dorsal fin and the antenna(s) are arranged in a lower portion of this dorsal fin.

In a second type of antenna positioning selection, the outer structural element is a dorsal fin and the antenna(s) are arranged in an upper portion of this dorsal fin.

In a third type of antenna positioning selection, the outer structural element is a wing.

These embodiments relating to the positioning of the antennas may be combined in all possible ways, some antennas being able for example to be arranged in the dorsal fin, in the top and/or bottom portion, and/or other antennas being able to be in a or two wing(s). In particular, the antennas distributed at different locations on the aerodyne and according to different orientations could provide additional information, or secure communications through deliberate redundancies.

In particular embodiments, the outer structural element(s) is (are) composed at least partially of a material selected from carbon fiber reinforced polymer or CFRP (standing for Carbon Fiber Reinforced Polymer), Kevlar fiber reinforced polymer or KFRP (standing for Kevlar Fiber Reinforced Polymer), and glass fiber reinforced polymer or GFRP (standing for Glass Fiber Reinforced Polymer).

Another object of the description is an aerodyne outer structural assembly comprising an outer structural element with an airfoil surface adapted to be mounted to a fuselage of an aerodyne and configured to confer aerodynamic properties to the aerodyne. This outer structural element comprises at least at least one outer shell and is provided with at least one antenna.

According to the description, this(these) antenna(s) is(are) arranged inside the outer structural element while being structurally dissociated from this(these) outer shell(s). In addition, at least one portion of this(these) outer shell(s) is substantially transparent to at least one range of radio frequencies, so that the antenna(s) could perform an operation selected among at least a reception and a transmission of radio waves through this(these) portion(s) of the outer shell(s).

Thus, such an outer structural assembly could be made separately while integrating therein the desired antennas in an appropriate manner, and then be fastened to an aerodyne, for example, after packaging and transport.

Advantageously, it is suitable for an aerodyne in accordance with any one of the embodiments disclosed hereinabove.

The description also relates to a method for arranging at least one antenna in an aerodyne comprising a fuselage and at least one outer structural element with an airfoil surface mounted to the fuselage and configured to confer aerodynamic properties to the aerodyne. This outer structural element comprises at least one outer shell.

According to the description, the method comprises the arrangement of the antenna(s) inside the outer structural element in a manner structurally dissociated from the outer shell(s). In addition, at least one portion of this(these) outer shell(s) is substantially transparent to at least one range of radio frequencies, so that this(these) antenna(s) could perform an operation selected among at least a reception and a transmission of radio waves through this(these) portion(s) of the outer shell(s).

Advantageously, this method is suitable for making an aerodyne in accordance with any one of the embodiments hereinabove.

The invention also relates to a method for arranging a set of antennas adapted to emit or receive in a radio frequency range in an existing aerodyne implemented either during an initial installation operation, or in a subsequent maintenance or upgrade operation, said method comprising the steps of:

dismounting at least one component of a structural element external to the airfoil surface of the existing aerodyne, the component being substantially transparent to the radio frequency range; setting up the antenna set in an area cleared by the dismount of step; adjusting an electronic and electrical harness connecting the antenna set to a radio communication system and to an electrical power supply inside the fuselage; reforming of the outer structural element so as to cover the antenna set in place.

The at least one dismounting component may be a cowl of the aerodyne.

The set-up step may comprise a step of fastening an antenna support structure on the fuselage. The reforming step may comprise a step of remounting the dismounted component(s).

### PRESENTATION OF THE FIGURES

The invention will be better understood and other features and advantages will appear more clearly in light of the description hereinafter of embodiments, given without limitation with reference to the accompanying drawings wherein:

FIG. 1 represents an airliner according to several embodiments allowing making it compliant with an aerodyne according to the description;

FIG. 2 is a block diagram functionally illustrating an operation with satellite communications of an aerodyne in accordance with a particular embodiment (antennas in the bottom portion of the dorsal fin);

FIG. 3 represents schematically and in a simplified manner a radiation angular distribution of antennas in flight for an aerodyne of the type of FIG. 2;

FIG. 4 illustrates more specifically, in cross-section and in partial view, an example of the arrangement of flat antennas in the bottom portion of the dorsal fin, corresponding to the embodiment of FIGS. 2 and 3;

FIG. 5 shows, in longitudinal section and in partial view, the example of FIG. 4;

FIG. 6 represents, in side view, the components of a dorsal fin set, wherein antennas could be installed in accordance with the example illustrated in FIGS. 4 and 5;

FIG. 7 shows a lower part for covering the dorsal fin at the fuselage level, called a shoe, the latter forming part of the dorsal fin set of FIG. 6 and being intended to set up antennas in accordance with the example FIGS. 4 and 5;

FIG. 8 shows a corresponding fuselage area in the absence of the shoe of FIG. 7;

FIG. 9 shows the fuselage area of FIG. 8 after fastening support legs by gluing;

FIG. 10 represents, in perspective, a support structure configured for the positioning of antennas and intended to be installed in the fuselage area of FIGS. 8 and 9;

FIG. 11 shows the fuselage area of FIGS. 8 and 9 after set-up of the support structure of FIG. 10 fastened on the support legs of FIG. 9;

FIG. 12 shows, in perspective, the fuselage area with a support structure of FIG. 11 after set-up of panels for fastening flat antennas;

FIG. 13 represents, in side view, the fuselage area with a support structure equipped with the panels of FIG. 12;

FIG. 14 shows an example of a block of antenna arrays that could be used for an aerodyne according to the description, and more specifically in positioning in panels of a support structure such as those of FIGS. 12 and 13;

FIG. 15 is an exploded view of the antenna array block of FIG. 14;

FIG. 16 shows a functional architecture of radio communications, which could be used in particular in combination with one or more antenna array block(s) of FIGS. 14 and 15 in an aerodyne in accordance with the description;

FIG. 17 is a block diagram illustrating connections between four antenna array blocks of the type of FIGS. 14 and 15 in position and processing modems which could form part of the functional architecture of FIG. 16;

FIG. 18 schematises an electrical and electronic wiring harness within an aerodyne of the type of FIG. 2;

FIG. 19 is a photo showing an installation for testing antenna arrays such as, for example, those of FIGS. 14 and 15 in position in a shoe such as that of FIG. 7;

FIG. 20 partially shows a variant of a support structure with antenna array blocks;

FIG. 21 schematically represents in top view the support structure with antenna array blocks of FIG. 20, in position in a shoe such as for example that of FIG. 7;

FIG. 22 is a principle illustration schematising in cross-section different methods for installing antenna panels inside a shoe, for example in connection with FIG. 13 or FIGS. 20 and 21;

FIG. 23 schematically shows in cross-section another method for installing antenna panels besides those of FIG. 22;

FIG. 24 is a block diagram functionally showing an aerodyne in accordance with the embodiment of FIG. 2, with another type of antenna arrays besides those of the previous figures;

FIG. 25 is a block diagram functionally showing an aerodyne in accordance with a particular embodiment distinct from that of FIG. 2 (antennas inside a wing on the fuselage side);

FIG. 26 shows a flowchart for implementing an antenna arrangement method according to the present description, in the context of an adaptation or maintenance of an operational aircraft;

FIG. 27 shows a flowchart for implementing an antenna arrangement method according to the present description, in the context of an aerodyne construction or transformation.

In the figures, identical or similar elements bear the same references. In addition, the suffixes “A” and “B” used for references conventionally specify elements as being located respectively on the right or left side of an aerodyne in the direction of navigation.

### DETAILED DESCRIPTION OF EMBODIMENTS

The present description illustrates the principles disclosed such that a person skilled in the art is able to design various modalities which, although not explicitly described or shown, incorporate the principles of the description and fall within its spirit and its scope.

All of the examples and the conditional language disclosed herein are intended for explanatory purposes to help the reader understand the principles of the description and the concepts developed by the inventors to extend the state of the art, and should be interpreted as not being restricted to such specifically described examples and conditions.

In addition, all mentions of principles, aspects and embodiments of the description, as well as of corresponding specific examples, are intended to cover both structural and functional equivalents. Such equivalents are also intended to include both known equivalents and equivalents that will be developed in the future, namely all developed elements that fill the same function, independently of their structure.

Thus, for example, a person skilled in the art will appreciate that the block diagrams presented herein provide conceptual views incorporating the principles of the description.

The terms “suitable for” and “configured for” are used in this description to broadly cover an initial configuration, a subsequent adaptation, a complement, or any combination of these.

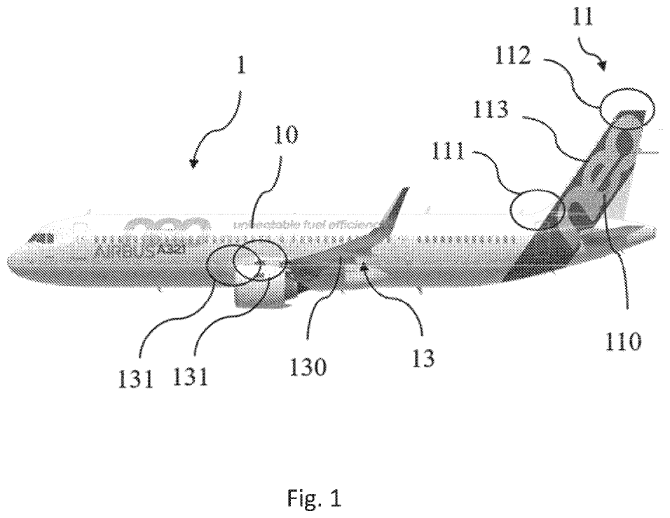

An aircraft 1 (FIG. 1), which may for example be an airliner such as that one commercialised under the brand A321 by the Airbus company, has an airframe including a fuselage 10 and wings 13 provided with cowls 131 at their root for fastening to the fuselage 10, these cowls 131 being for example made of Kevlar fiber reinforced polymer (KFRP) and contributing to the aerodynamic fairing of the wings 13 in addition to a metallic main portion 130. The aircraft 1 also comprises a tail including a dorsal fin 11 and horizontal stabilisers 12, the dorsal fin 11 being provided with cowls such as a lower cowl 111 at its area of fastening to the fuselage 10, called shoe (“shoe cover”), a cowl 112 at the upper end of the tail fin 11, called hood (“hood cover”), and an elongate cowl at the upper portion of the tail fin 11 and connecting the shoe 111 and the hood 112 called longitudinal cowl (“roof cover”), these cowls 111, 112 and 113 contributing to the aerodynamic fairing of the tail fin 11 in addition to a metallic main portion 110. For example, the shoe 111 and the hood 113 are made of a glass fiber reinforced polymer (GFRP).

The aircraft 1 is particularised by the presence of one or more antenna(s) inside the tail fin 11 and/or at least one of the wings 13, and more specifically inside at least one of their portions consisting of the shoe 111 and the tail fin cover 112 and the wing cowls 131, as detailed hereinafter.

It should be understood that this list of portions of outer structural elements with an airfoil surface is not exhaustive, and that in variants, antennas may be placed for example inside the longitudinal cowl 112 made of GFRP.

In some embodiments, antennas are present at various locations of the aircraft 1 and are operated together, for example by combined processing of signals obtained from these antennas and/or of transmitted signals by these antennas. Thus, it is possible to enrich the transmission and reception capacities, in particular in terms of range, directional coverage and/or gain.

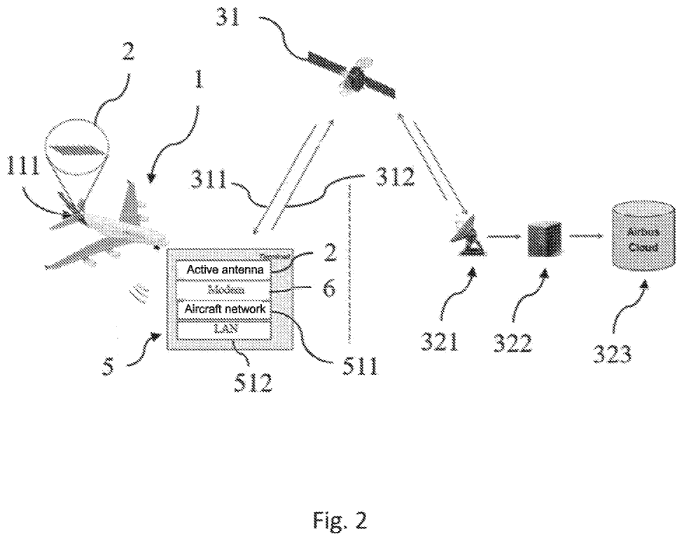

The operation of an antenna 2 inside the shoe 111 of the tail fin 11 in the aircraft 1 is performed, for example, as disclosed hereinafter in connection with FIG. 2 (multiple antennas of the type of the antenna 2 which could be active together in the shoe 111). Inside the aircraft 1, the antenna 2 is integrated into an on-board communication system 5 also comprising a modem 6, an electronic and electrical network 511 of the aircraft 1, and a local wireless network (called LAN standing for “Local Area Network”) 512.

While the active antenna 2 is operating, the aircraft 1 communicates with a satellite 31 in reception (downlink 311, for example at 10 Gbit/s) and in transmission (uplink 312, for example at 1 Gbit/s), the satellite 31 being in radio link with a gateway parabolic antenna 321 on the ground, which is connected to a processing centre 322 and via the latter to computer resources 323 (for example of the cloud type) and associated interfaces. The possible bandwidth depends above all on the capacities of the satellite(s) in connection with the aircraft.

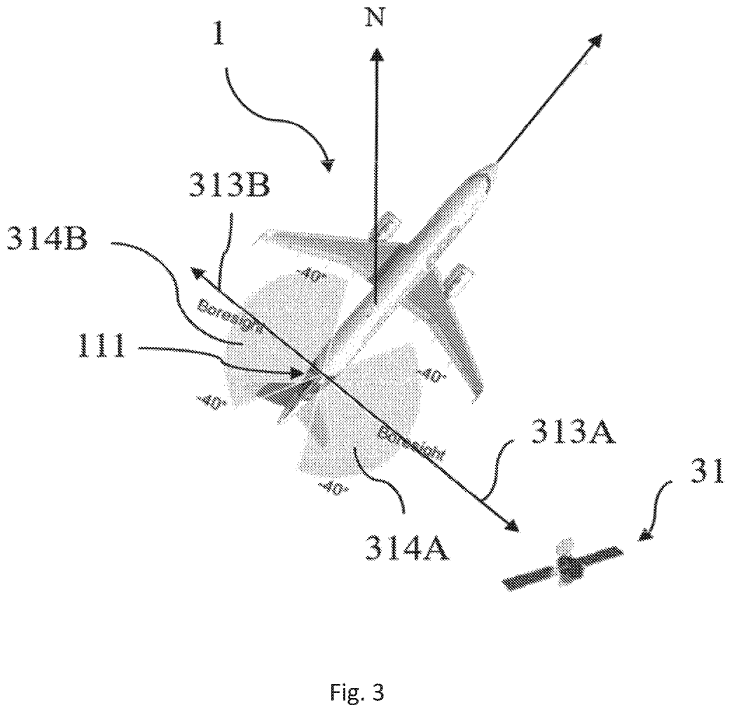

The communications between the aircraft 1 and the satellite 31, a block diagram of which is shown in FIG. 3, rely on the capacities of transmission via antenna 2 through the shoe 111 of the tail fin 11. The location of the antenna 2 could provide right 313A or left 313B sight lines (right and left being defined with respect to the direction of navigation) substantially perpendicular to the axis of the fuselage 10, and relatively wide radiation angular apertures 314A or 314B respectively to the right and to the left (the representations of the radiation being purely for principle illustration and not reflecting actual radiation patterns).

The combination of at least two antennas of the type of antenna 2 in the shoe 111, properly positioned and oriented, enables effective radio communications both to the right and to the left of the aircraft 1, in accordance with the standard diagram of FIG. 3. Thus, a selection of active antennas could be performed in particular according to a spatial and directional positioning of the aircraft 1 with respect to communication satellites (in particular taking into account the azimuthal positions of these satellites with respect to aircraft 1).

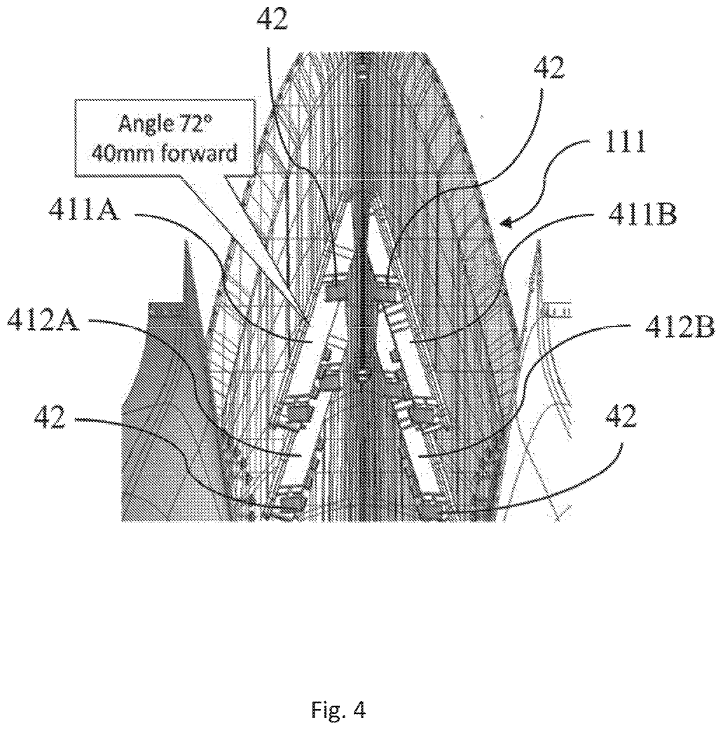

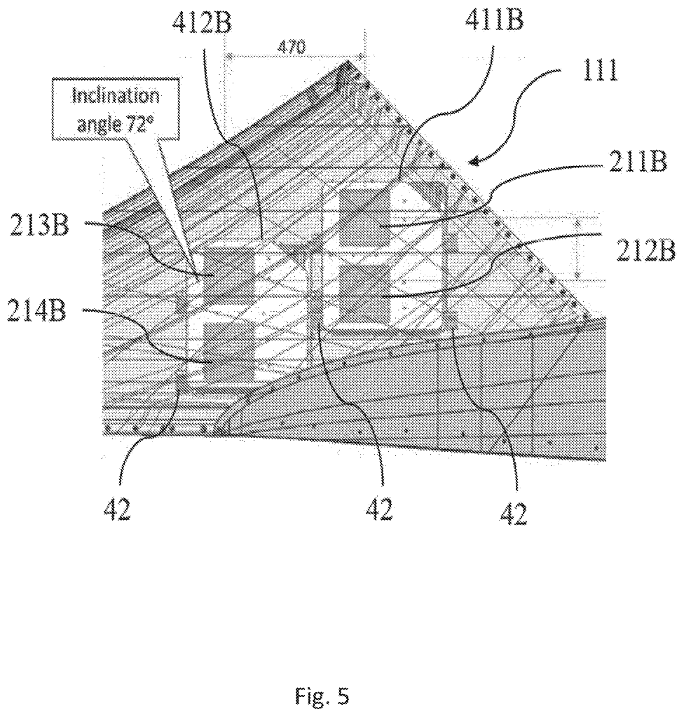

For example, such an arrangement, illustrated in FIGS. 4 and 5, uses eight antenna blocks including to the left four blocks of flat antenna arrays 211B, 212B, 213B and 214B, and symmetrically to the right four blocks of flat antenna arrays that are not represented. These antennas are close in their upper portion to a vertical plane of symmetry of the shoe 111, and are inclined by about 72° with respect to a horizontal plane (FIG. 4), so that they have high lines of sight raised by about 18° with respect to the horizontal of the aircraft 1 perpendicular to the axis of the fuselage 10.

The antenna blocks 211B, 212B, 213B and 214B to the left and the corresponding ones to the right are carried in pairs by panels 411B and 412B to the left, and symmetrically to the right 411A and 412A, which impart the desired inclinations to the antennas (FIG. 5), and are articulated by means of hinges 42 to one or more structure(s) that are not represented. For purely illustrative purposes, the panels 411A, 412A, 411B and 412B have dimensions in height and in width in the range of 50 cm, and the antenna blocks of the right panels 411A and 412A are spaced apart horizontally by a distance comprised between 45 and 50 cm (for example 47 cm, the same applies for the antenna blocks of the left panels 411B and 412B).

A partition may be made between antennas for reception and transmission, the antenna blocks 211B and 212B being, for example, used for the transmission and the antenna blocks 213B and 214B for reception. The distance between the antenna blocks could then make it possible an operation in full duplex mode (“full duplex”), while avoiding interference between reception and emission.

The number and/or the size of the antenna blocks may be adapted according to the needs and the available space, the examples disclosed in the present application not being restrictive.

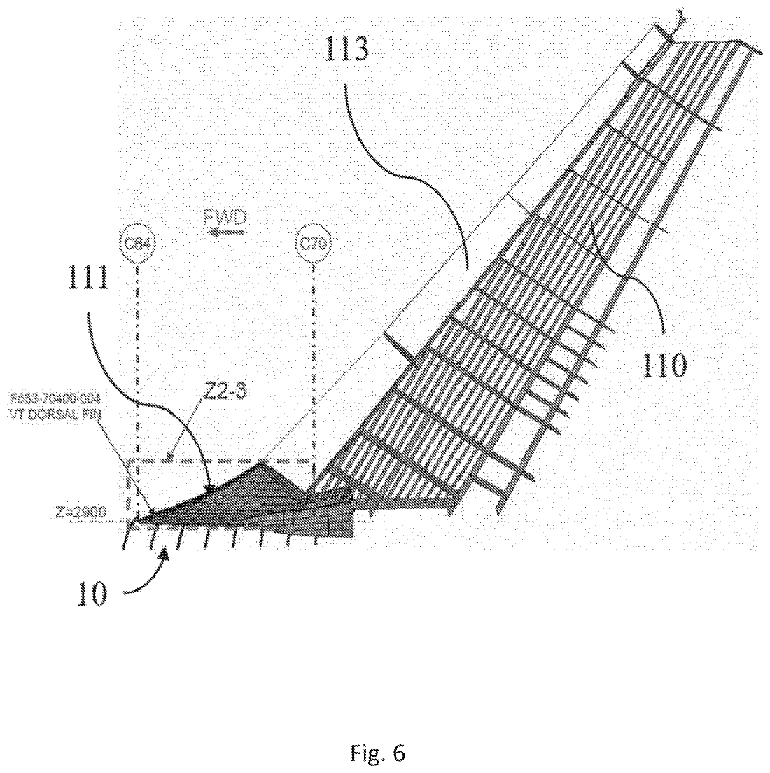

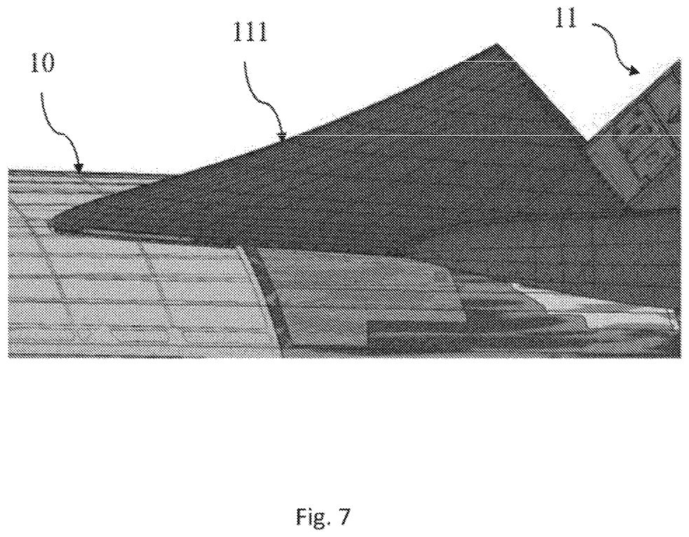

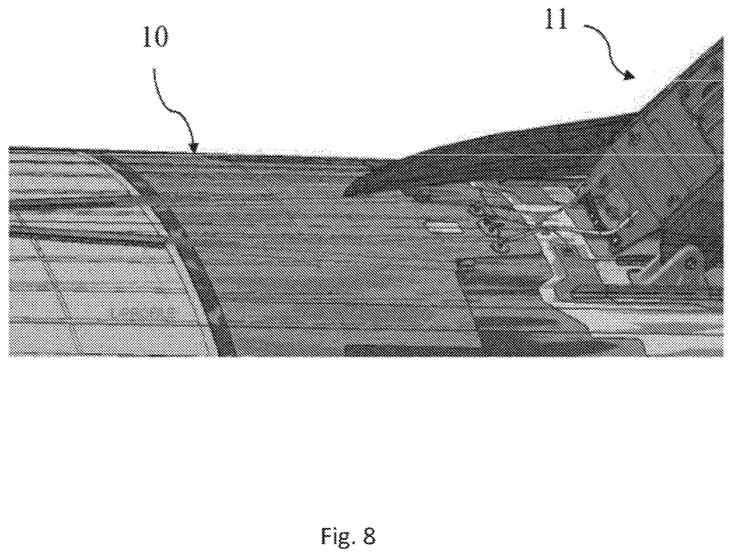

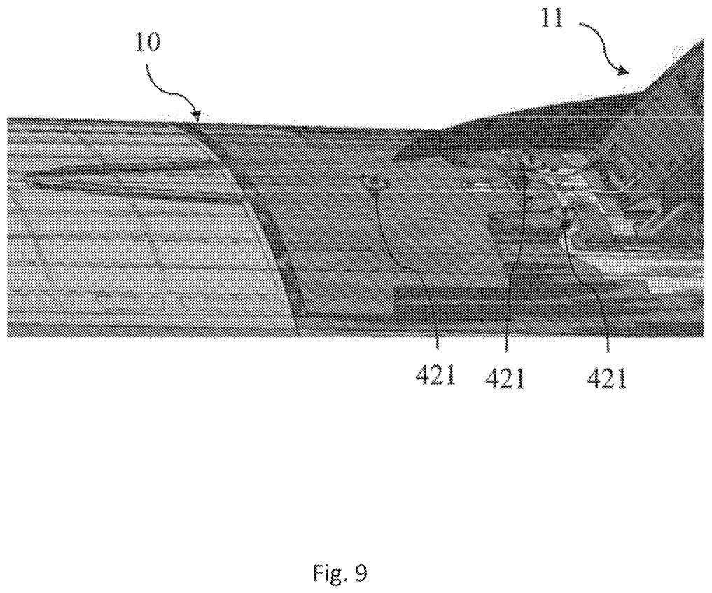

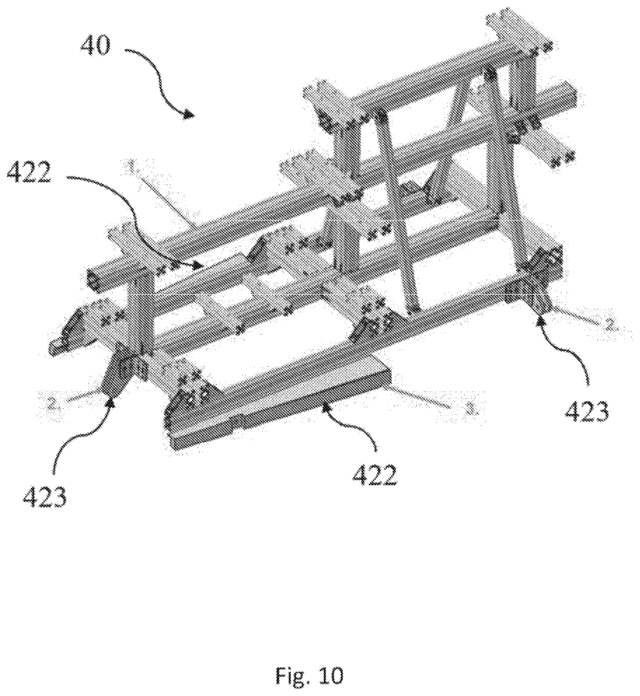

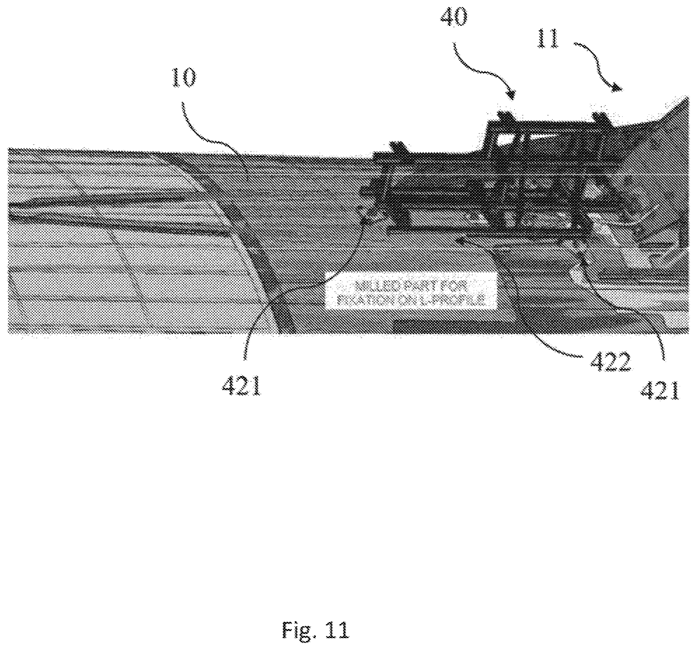

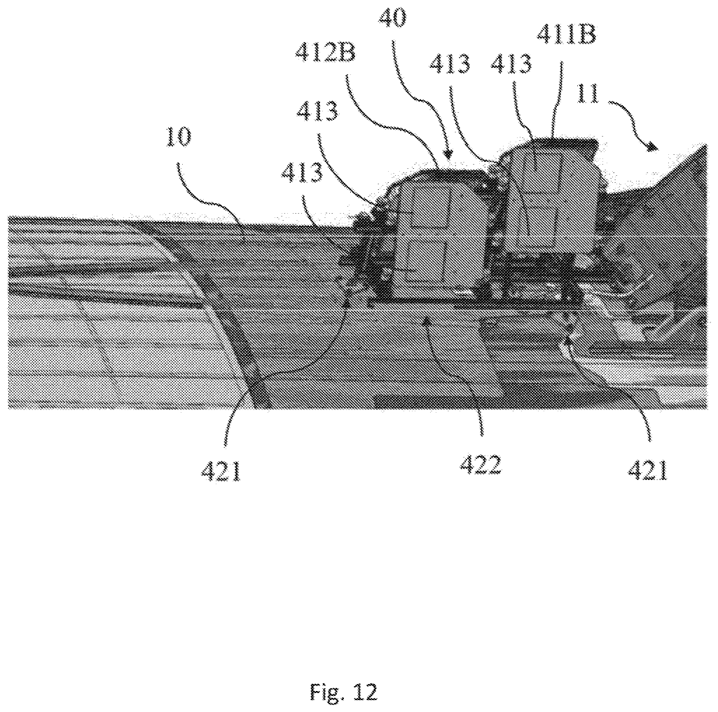

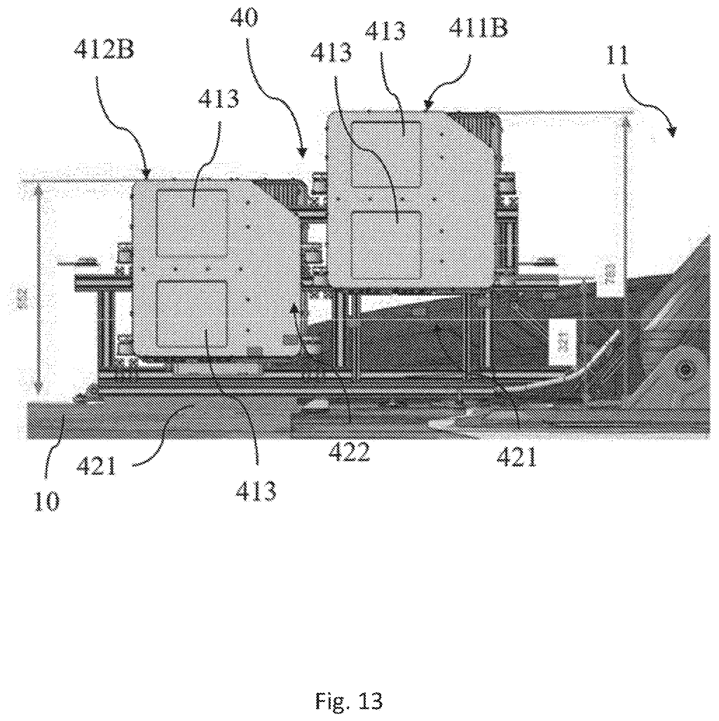

A method for setting up such antennas 2 inside the shoe 111 of an existing aircraft may be carried out, for example, as follows, with reference to FIGS. 6 to 13. In the absence of any installation of the antennas 2, the shoe 111 is removably fastened on the fuselage 10 and borders the metallic main portion 110 of the dorsal fin 11, the longitudinal cowl 113 being positioned on the main portion 110 in the continuation of the shoe 111 (FIG. 6). For example, the shoe has a length of about 1.20 m (along the axis of the fuselage), and is primarily made of GFRP, an adhesive film and a honeycomb structure. For installation, the longitudinal cowl 113 (FIG. 7) is removed, then the shoe 111 (FIG. 8) is dismounted, before fastening on the fuselage 10 (FIG. 9) support legs 421 (“brackets”, three in number in a triangle-like arrangement in the represented example), which will be used to fasten a support structure 40 (FIG. 10). Simple gluing of the legs 421, as represented, may be satisfactory to this end. The support structure 40 is configured to be fastened to the fuselage 10, on the one hand, by milled portions 422 and, on the other hand, to the feet 421 respectively by fastening elements 423, and to receive panels which hold flat antennas, such as the panels 411A, 412A, 411B and 412B hereinabove. Thus, the support structure 40 is fastened to the fuselage 10 at a location intended for the shoe 111 (FIG. 11). Afterwards, the panels 411A, 412A, 411B and 412B are placed in position on the support structure 40 (FIGS. 12 and 13), and after installation of the corresponding flat antenna array blocks, for example 211B, 212B, 213B and 214B on the left side, in dedicated clearances 413 of the panels, and appropriate (electrical and electronic) wiring, the shoe 111 could be put in place again.

In appropriate configurations, all of these operations could turn out to be particularly simple and economic to implement on existing aircrafts. What is more, once the installation is completed, the maintenance could require only limited effort, for example both for the maintenance of the antennas and the wiring and for that of the support structure 40.

More specifically, in examples with favourable conditions, it has been noticed that all operations could be carried out in less than 5 hours, access to the antenna positioning area and wiring being easy.

More details are given hereinafter on the configuration of the antennas 2 and their associated components, in particular embodiments. To this end, it should be noted that the local integration of functionalities associated with the antennas under the shoe 111 could be performed at different degrees of complexity, whereas functionalities not locally integrated could be displaced inside the fuselage 10 by using an appropriate connection system.

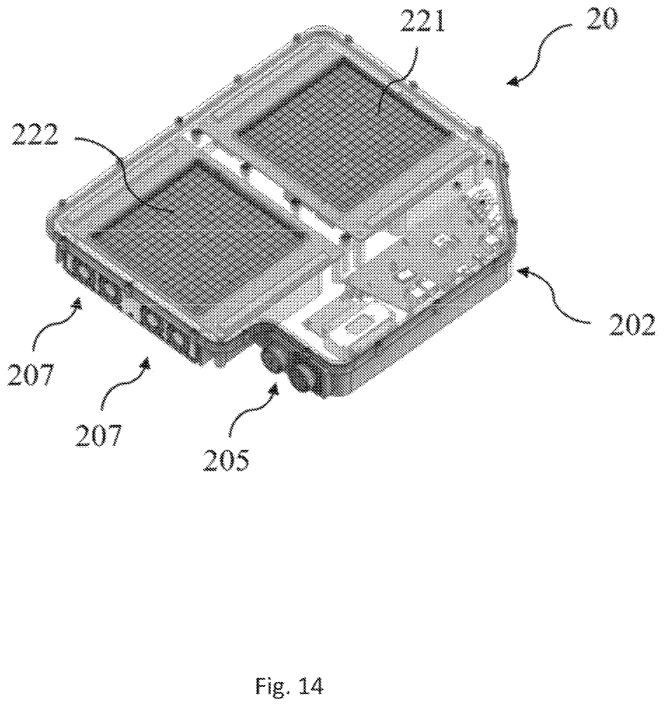

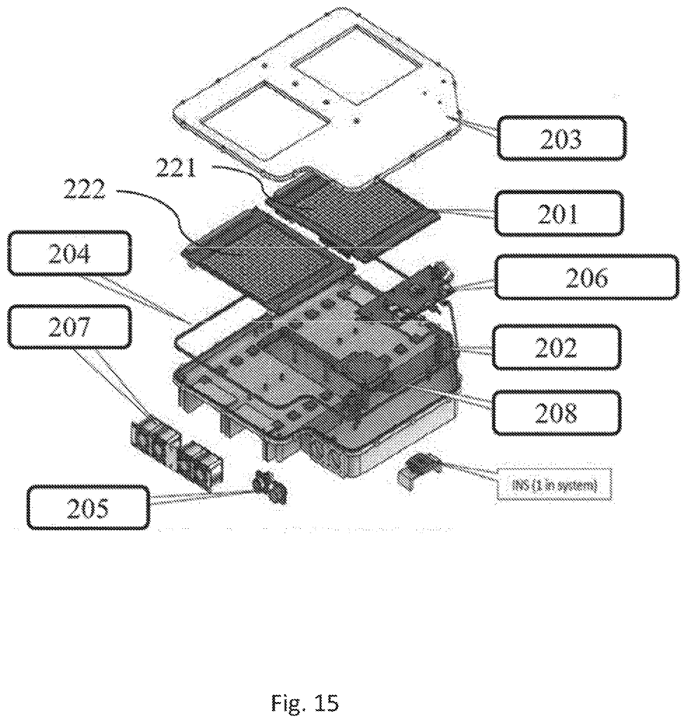

A block of antennas 20, as represented in FIGS. 14 and 15, comprises, for example, two sub-arrays 221 and 222 of 256 elements (“patches”), and is identical in reception or transmission. This antenna block 20 may be in the form of a printed circuit board or PCB (standing for “Printed Circuit Board”). In the present example, wherein the antenna boards 201 are incorporated with other elements in an aluminium case 202 with a silicone seal 204 and covered with a plastic top 203, the modem functionality is reduced to controller boards 206 (for antenna control and traceability), one or more modem(s) being provided inside the fuselage 10 to perform the associated effective processing. The antenna block 20 also comprises connectors 205, a ventilation assembly 207 (allowing cooling a passive metal plate), and a direct current electrical power supply brick 208.

The antenna block 20, and its two sub-arrays 221 and 222, are multibeam, and are for example suitable for satellite communications with satellites both in geostationary earth orbit or GEO (standing for “Geostationary Earth Orbit”) and in low earth orbit or LEO (standing for “Low Earth Orbit”). For example, the antenna block 20 has a length (in the direction covering the two sub-arrays 221 and 222) comprised between 46 and 47 cm, a width comprised between 42 and 43 cm, and a depth in the range of 5.5 cm.

The set formed by the support structure 40 provided with the panels 411A, 412A, 411B and 412B and with the antenna blocks 20 may have a relatively limited weight, for example in the range of 50 kg.

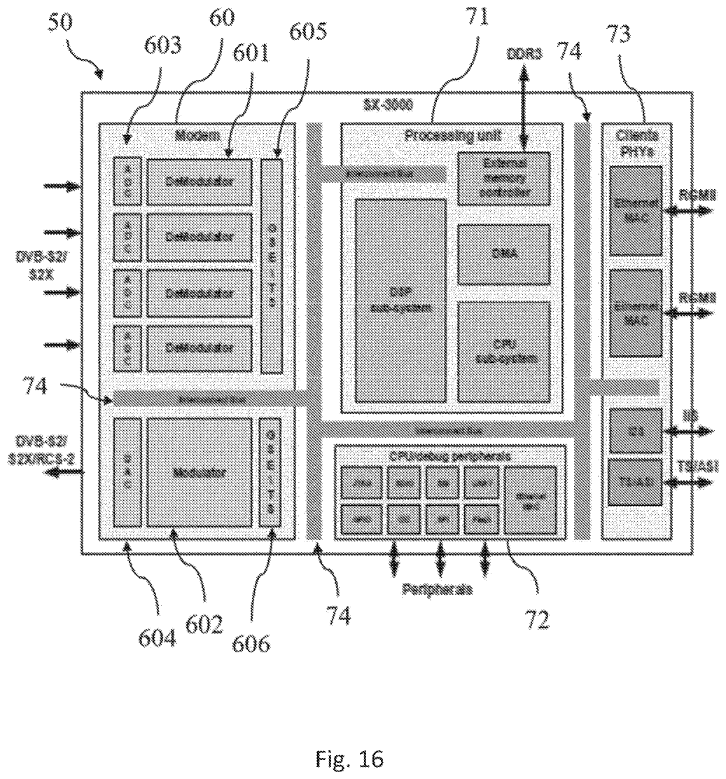

A radio communication system 50, cooperating with the antenna blocks such as the antenna block 20 hereinabove and installed inside the fuselage 10, primarily comprises, for example, the following elements, with reference to the principle architecture represented in FIG. 16. In addition to a modem portion 60, the radio communication system 50 includes:

a processing unit 71 comprising a digital signal processor or DSP (standing for “Digital Signal Processor”) subsystem, a processor or CPU (standing for “Central Processing Unit”) subsystem, a direct memory access or DMA (standing for “Direct Memory Access”) controller and an external memory controller,

connections 72 for linking to peripherals,

physical and data link layers (MAC layer, standing for “Medium Access Control”) 73 for communications with clients, including user interfaces, and

buses 74 interconnecting all of the elements of the radio communication system 50.

More specifically, the modem portion 60 includes a demodulation sub-portion 601 (with parallel demodulation units) and a modulation sub-portion 602, the demodulation being associated in reception upstream with analog-to-digital converters 603 and downstream with modules 605 for extracting data from transport trains, in particular, by decapsulation, and the modulation being associated in transmission upstream with modules 606 for preparing transport trains, in particular, by encapsulation and downstream with digital-to-analog converters 604.

The signals transmitted and received by the radio communication system 50 via the modem portion 60 are for example satellite signals in accordance with the DVB-S2 standard (standing for “Digital Video Broadcasting”—second generation for satellite broadcasting).

In addition, the antenna blocks 20 and the modem portion 60 could in particular be configured for transmissions in Ku and/or Ka bands. For example, the antenna blocks 20 are configured to receive and transmit in the Ku band, between 10.7 and 12.7 GHz in reception and between 14 and 14.5 GHz in transmission, with a transmission efficiency in the range of 80%. Still for example, these antenna blocks 20 have in transmission an effective isotropy radiated power, or EIRP, of 32 dBW and in reception have a performance factor G/T (gain to noise temperature) of 3 db/K.

Also, the antenna blocks 20 and the modem portion 60 could be configured to perform beamforming with phase and gain adjustment for each path, thereby providing multibeam capabilities. For example, up to 32 distinct beams could be generated and up to 32 distinct beams could be processed (32 signal inputs and 32 signal outputs), with a simultaneously processed signal bandwidth of 880 MHz (split between the channels). In other examples, up to 16 beams, or up to 8 beams could be processed.

For example, the antenna blocks 20 may use components developed by the company SatixFy such as a specialised integrated circuit or ASIC (standing for “Application Specific Integrated Circuit”) for an active flat antenna array, commercialised under the brand “PRIME”, and a radio frequency integrated component or RFIC, interfaced between a phased antenna array and a “PRIME” ASIC and acting as a front module, commercialised under the brand “BEAT”.

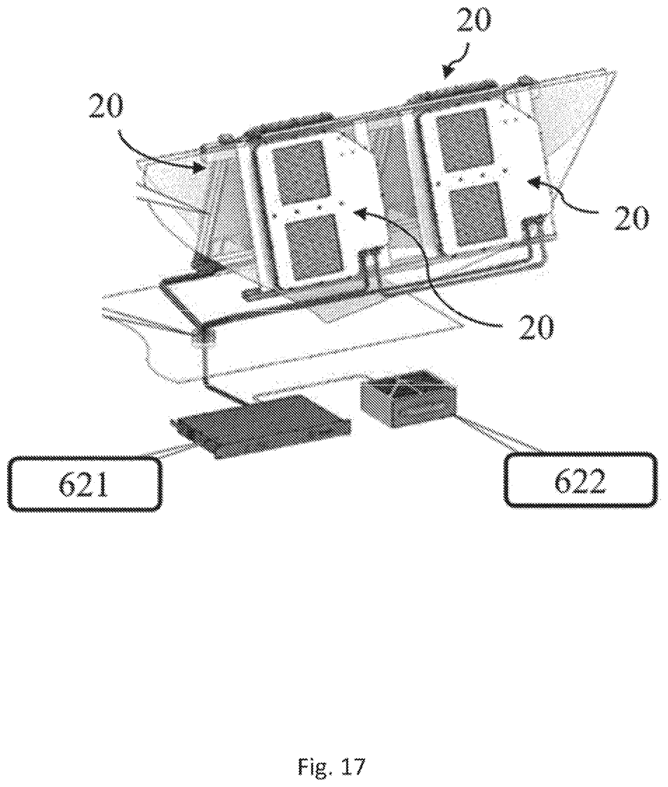

Very schematically, as shown in FIG. 17, the antenna blocks 20 intended to be arranged inside the shoe 111 are connected in series to two modems 621 and 622 intended to be arranged inside the fuselage 10.

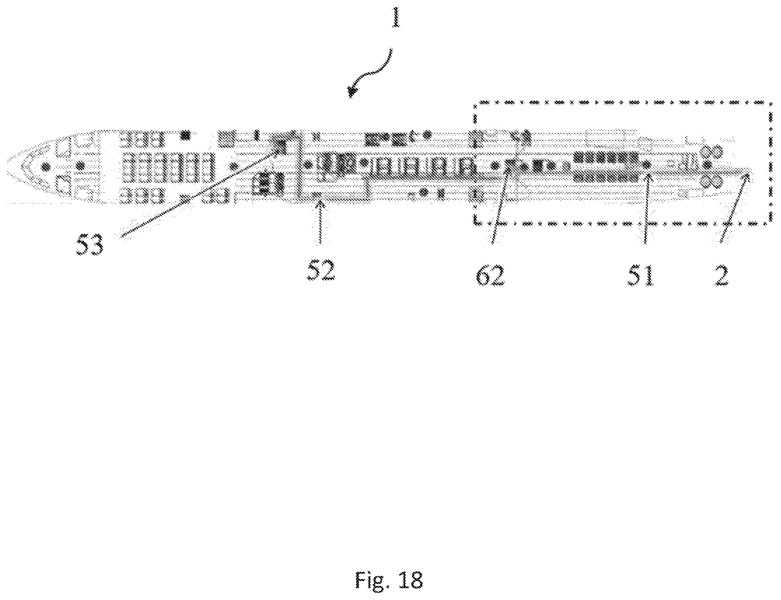

For illustration, an electronic and electrical wiring harness between the antennas 2 arranged inside the shoe 111 and the functionalities present inside the fuselage 10 may, for example, as in FIG. 18, comprise an electronic path 51 for routing to one or more modem(s) 62 (for example the modems 621 and 622 hereinabove) and an electrical path 52 to an electrical power supply electric 53 at the front of the device. A small diameter feedthrough proximate to the antennas 2 at the fuselage 10, for example at a distance comprised between 1 m and 1.5 m, is enough to pass the appropriate wiring to a pressurised area without posing any particular difficulty, as known to a person skilled in the art. Inside the fuselage 10, the wiring path may for example pass through ceilings.

The electrical power supply may be divided into several cables (for example four) in order to avoid too high amperage. Maximum values in the range of 12.5 A for amperage and 28 V direct current for voltage are, for example, met. The possible pre-existence of holes in the fuselage proximate to the shoe 111, used in some aircraft models 1 for preliminary or periodic performance tests, facilitates even more the set-up of the harness. Otherwise, it is possible to pierce the structure of the fuselage 10 with minimal intervention and in a safe manner known to a person skilled in the art.

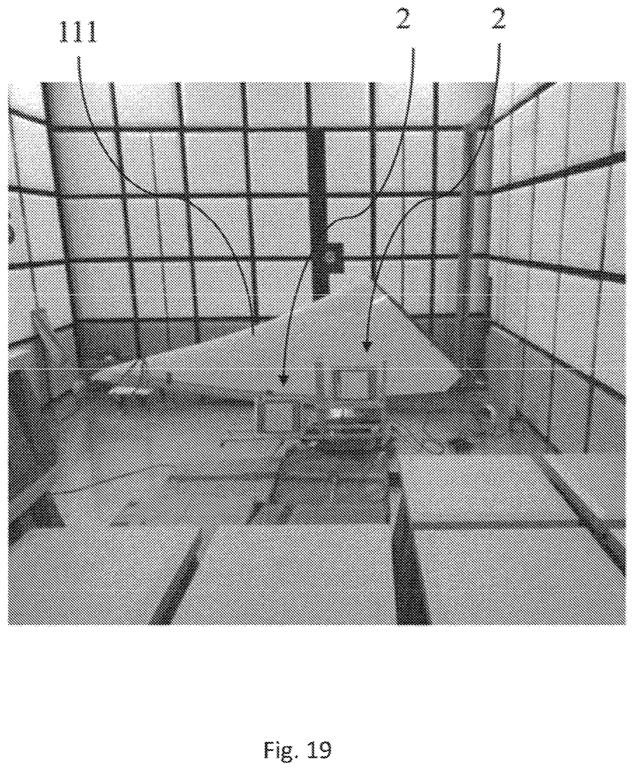

It could be noted that tests conducted in an anechoic chamber in reception and in transmission on examples like those disclosed hereinabove, as represented in the photo of FIG. 19, have allowed proving the good resistance to radiation of antennas 2 when they are positioned inside a shoe 111, and to obtain relevant ranges of use in frequencies. The particular cases that have been examined have undergone measurements of EIRP in transmission and of received signal strength indicator and of RSSI (standing for “Received Signal Strength Indicator”) in reception, for waves with vertical or horizontal polarisation, different angles of incidence, and various frequencies. The obtained results have led to the observation of a preserved radiation pattern in the presence of the shoe 111 in comparison with measurements in its absence, with attenuation at different angles for different frequencies, and a satisfactory transparency of the shoe 111 for frequencies in the range of 11 GHz in reception and in the range of 14 GHz in transmission, a good trade-off being obtained in emission-reception with a common frequency of 11.5 GHz (Ku band).

Tests have also been conducted on the ground on moving vehicles with the lower portion of the dorsal fin (shoe 111) mounted on the roof and available satellite links, and have thus confirmed the proper operation of the device under representative conditions.

In other embodiments of the antenna blocks, these directly incorporate substantial or complete functionalities of modems. It is then no longer necessary to provide inside the fuselage 10 modems such as those described before, and the harness could be simplified accordingly.

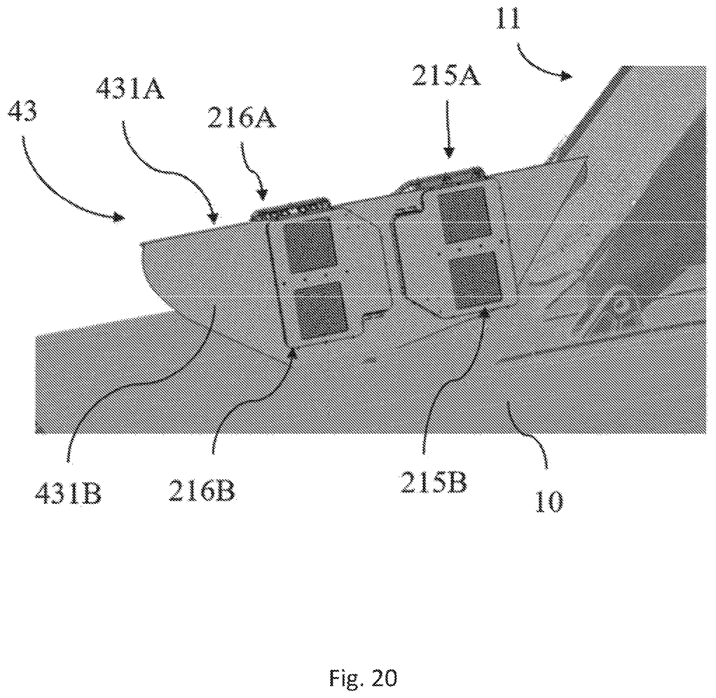

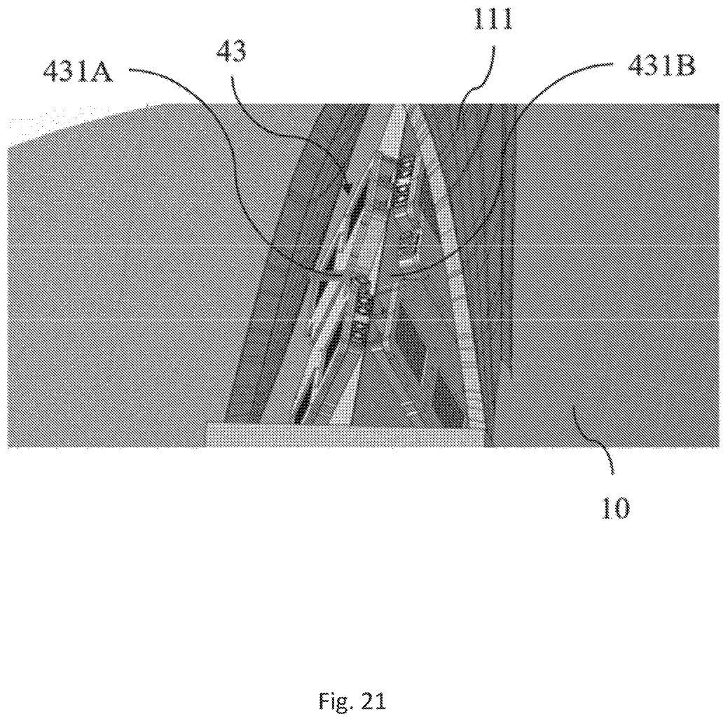

Another embodiment of a support structure besides that disclosed before, schematically represented in FIGS. 20 and 21 and referenced 43, comprises two tilted right 431A and left 431B panels, joined in their upper portion and arranged symmetrically with respect to a vertical plane in the axis of the fuselage 10. The support structure 43 is designed to receive four antenna blocks of the type 20 described hereinabove, including two antenna blocks 215A and 216A on the right panel 431A, and two antenna blocks 215B and 216B on the left panel 431B.

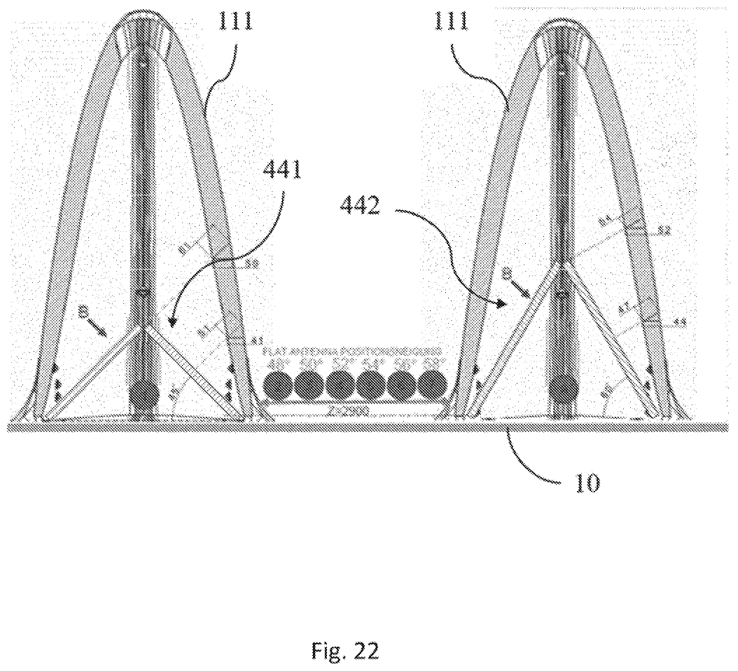

Different configurations of a support structure of this type could be achieved according to the present description, depending on the angles of inclination of such panels 431A and 431B with respect to the horizontal. Thus, principle illustrations show in FIG. 22, in position inside the shoe 111, a support structure 441 with angles of inclination of 45°, a support structure 442 with angles of inclination of 60°, and suggest various intermediate inclinations of 48°, 50°, 52°, 54°, 56° and 58° respectively.

In a particular embodiment, a support structure comprises a mechanism, for example based on notches or hooks, which allows adjusting the inclination of the panels according to different angles. This embodiment may be particularly interesting for use in series of the same support structure model, because it allows for a flexible adaptation of the configuration of this structure to several types of aerodynes, of outer structural elements selected for the positioning of antennas, of categories of antennas, or of radio communication applications.

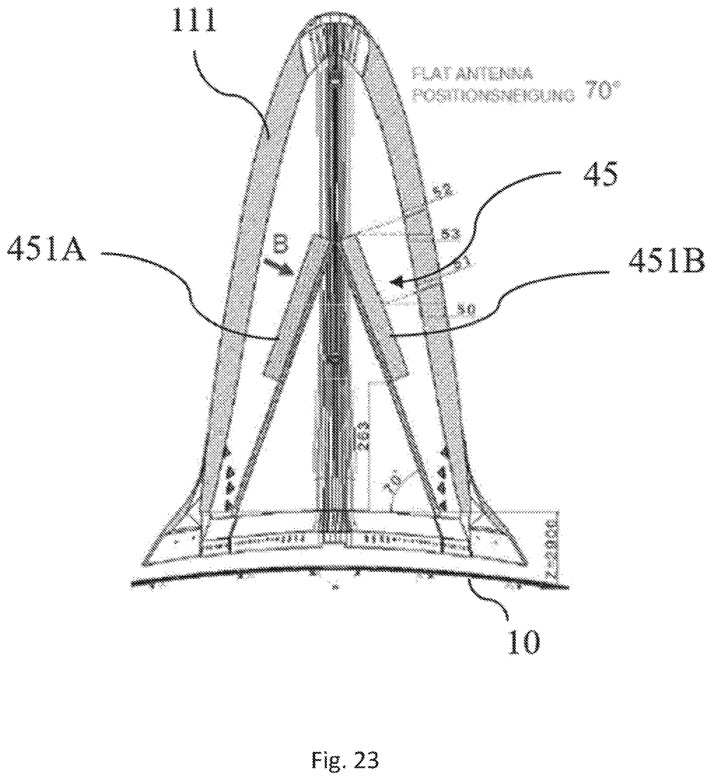

In another embodiment, schematically represented in FIG. 23, a support structure 45 has for its right panel 451A and its left panel 451B angles of inclination of 70°.

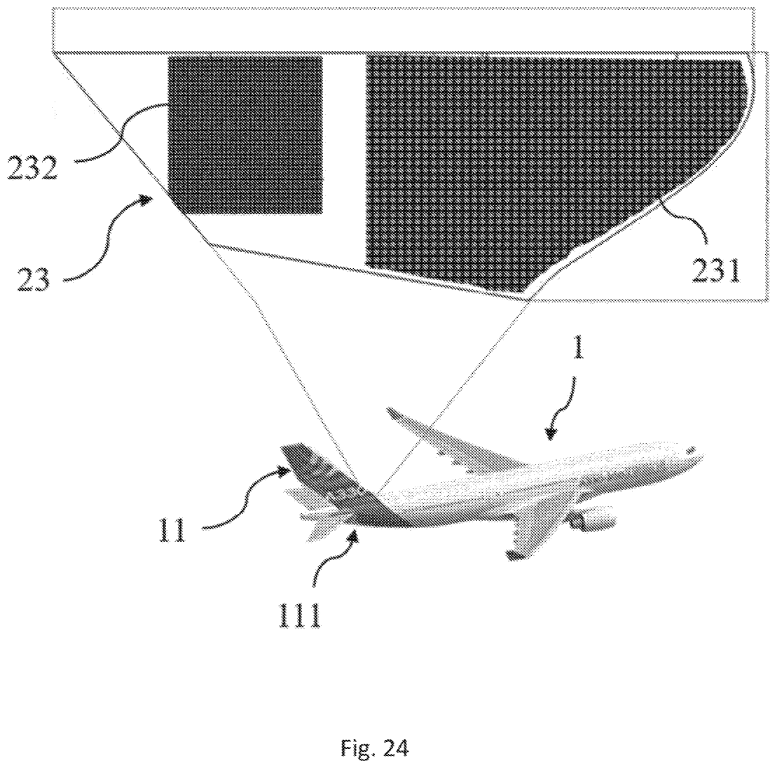

Other types of antennas besides those described before are possible. For example, as represented in FIG. 24, with the aircraft 1 possibly being for example an airliner such as that one commercialised under the brand A330 by the Airbus company, a block of antennas 23 comprises to the right a flat antenna array 231 extended to the right, and to the left, a flat antenna array 232 which is substantially square and smaller in size than the antenna array 231 and spaced therefrom. The antenna arrays 231 and 232 are intended respectively for the reception and the transmission of radio waves, the reception being more demanding in performance than in transmission. The space between the antennas 231 and 232 allows avoiding interferences between emission and reception in full duplex operation.

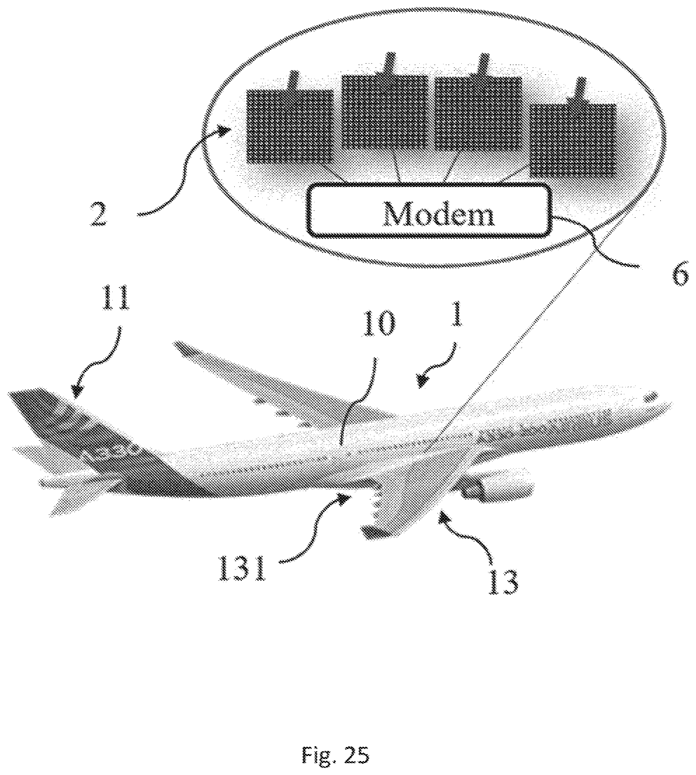

In another embodiment of the aircraft 1 (which for example could also be that one commercialised under the brand A330 by the Airbus company) represented in FIG. 25, which may be combined with the previous ones, antennas 2 are arranged inside at least one of the cowls 131 of the wings 13 in the vicinity of the fuselage 10. The antennas 2 are connected to one or more modem(s) 6 dedicated to the combined processing of the corresponding signals. Advantageously, the antennas operated in this configuration are small-sized, compared to those that could be installed inside a tail fin as disclosed before.

The radio communication systems 50 cooperating with the antenna blocks 2 may be in any suitable form known to a person skilled in the art to achieve the mentioned functions and to produce the mentioned effects or results. In particular, they may include apparatuses, components, or physical portions of apparatus(es) or component(s), whether these portions are grouped together in the same machine or in distinct machines, which might be remote within the considered aerodyne. Moreover, the signal processing functionalities could be performed in the form of hardware, software, firmware, or any mixed form thereof.

In turn, the antennas 2 may be arranged in any relevant area of the aircraft or in several ones of them, and the corresponding signals could be processed separately or together by means of the radio communication systems 50 in all technically feasible manners to achieve the mentioned functions and to produce the mentioned effects or results.

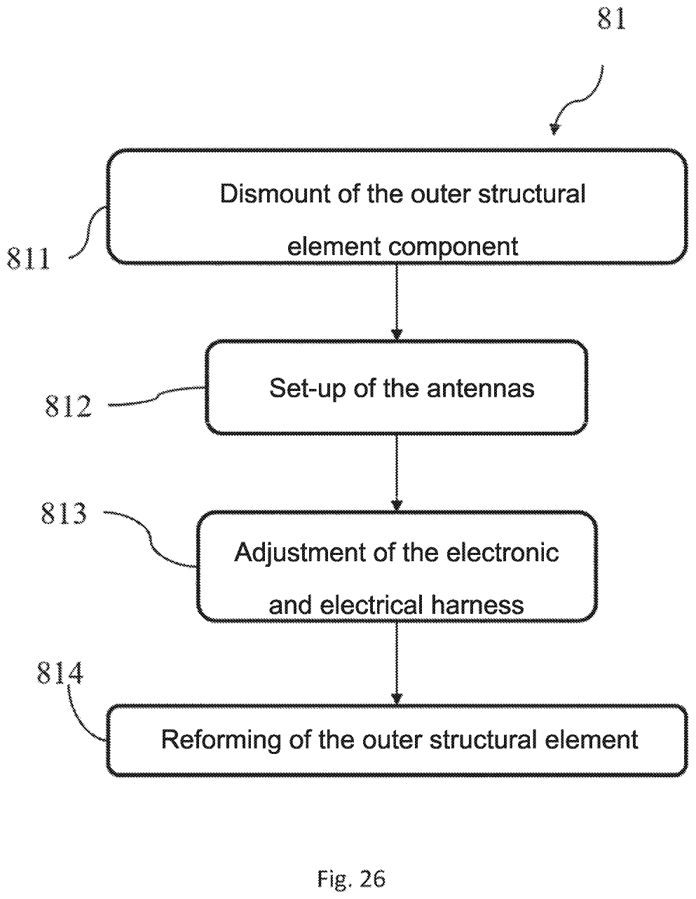

A method for arranging 81 a set of antennas in an existing aircraft could be implemented either during an initial installation operation, or in a subsequent maintenance or upgrade operation. Such a method 81 comprises, for example, the following steps, illustrated in FIG. 26:

first (step 811), dismounting at least one component (such as a cowl) from an outer structural element with an airfoil surface;

afterwards (step 812), setting up the antenna set in an area cleared by the dismounting of step 811, for example by fastening an antenna support structure to the fuselage;

adjusting (step 813) an electronic and electrical harness connecting the antenna set to a radio communication system and to an electrical power supply inside the fuselage;

reforming (step 814) the outer structural element, for example by remounting the dismounted component(s), so as to cover the antenna set in place.

Such an installation of antennas in existing aerodynes is particularly interesting, since it allows, at lower cost and with reduced effort, transforming aerodynes in operation in order to make them compliant with this description.

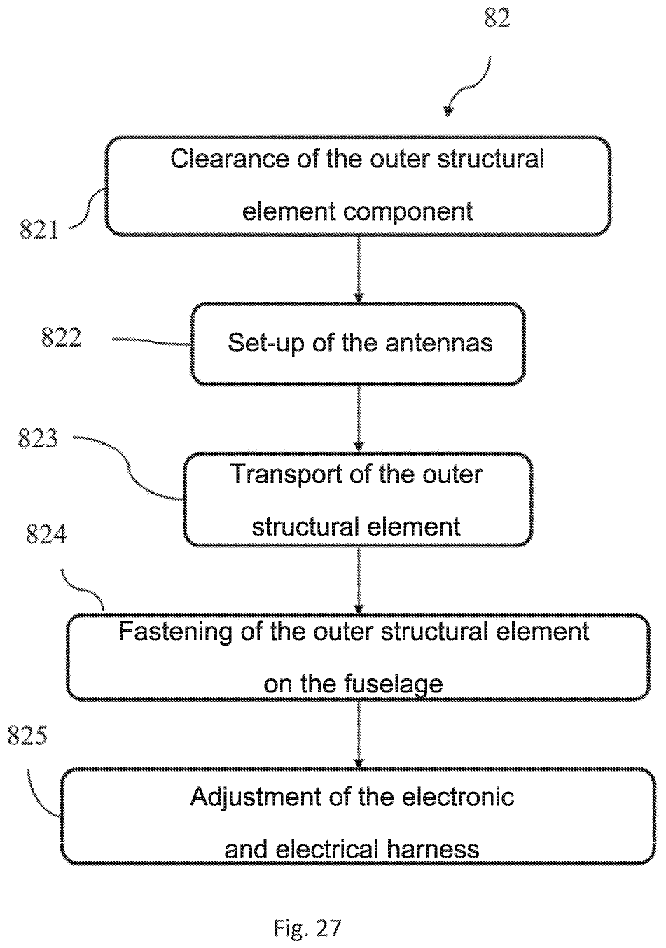

A method for arranging 82 a set of antennas in an aerodyne under construction could be implemented separately in an outer structural element with an airfoil before connection to the fuselage. Such a method 82 comprises for example the following steps, illustrated in FIG. 27:

firstly (step 821), clearing a set-up area inside the outer structural element, configured to receive at least one component (such as a cowl) of this element;

afterwards (step 822), setting up the antenna set in this cleared area, for example by fastening an antenna support structure, and covering the antenna set by placing the component(s);

transporting (step 823) the outer structural element to a construction site of an aerodyne;

fastening (step 824) the outer structural element on a fuselage, during the operations of constructing the aerodyne;

adjusting (step 825) an electronic and electrical harness connecting the antenna set to a radio communication system and to an electrical power supply inside the fuselage, possibly after dismounting the component(s) from the outer structural element then remounting after adjustments.

Such an installation of antennas upstream in elements intended for the construction of aerodynes is particularly interesting, because it allows implementing mass productions, for example of wings or tail fins, which could then be delivered or exported to remote locations. Thus, it is possible to rationalise the manufacture and reduce fixed costs, while centralising a corresponding expertise.

Many other examples of antennas, of radio communication systems and of set-up configurations in outer structural elements with an airfoil surface for aerodynes could also be developed while preserving the disclosed functionalities. Advantageously, the selection of these entities is performed jointly, while taking into account their interactions and the pursued purposes. For example, the positioning and the orientation of the antennas could be determined by means of support structures depending on the number, capacities and types of operation, and on the possibly combined processing (in emission and/or in reception) of these antennas.

In particular, although the antennas and radio communication systems described in the disclosure are dedicated to satellite transmissions, they could also consist of antennas of radio communication systems configured for terrestrial transmissions, for example intended for receptions and emissions in 4G and/or 5G, particularly useful in particular when the aerodyne is on a tarmac. The joint presence of antennas intended for satellite and terrestrial transmissions in an aerodyne could be particularly interesting. Other types of antennas besides flat antennas and/or arrays could also be used.

Besides, in addition to the installation of antennas inside a shoe or a tail fin hood, or a wing cowl at their root for fastening to the fuselage, these could also be installed for example (exclusively or in combination with some of the above arrangements) inside other portions of outer structural elements having the desired transparency to the radio waves to be received or transmitted (longitudinal tail fin cowl, horizontal stabiliser cowl, etc.). It may then be appropriate to provide an appropriate harness for the electronic and electrical connections, or other means filling similar functions.

In some embodiments, the antenna blocks are provided with a set of processing capabilities, in particular in terms of modems, which substantially reduce or make useless complementary processing carried out remotely inside the fuselage.

Examples of antenna support structures have been detailed in the description. However, all kinds of other support structures can be used, including mobile structures that can confer to the antennas orientations and/or positions that vary over time, in particular by remote-control or prior programming. Advantageously, the support structures offer the possibility of applying to the antenna positions and/or orientations inside the outer structural element with an airfoil surface, without these positions and/or orientations being determined by the outer shell of the outer structural element. Such a configuration may be implemented during the initial installation and/or during maintenance operations.

In particular embodiments, the support structures are fastened to the fuselage and have no direct structural connection with the outer structural element that surrounds them. In other embodiments, the support structures have at least one connection with this outer structural element, which may in particular form one or more complete link(s) and/or pivot link(s). The support structures may be fixed and have orientable flaps or panels, arms and/or fixing notches, allowing flexibly deciding on the position and the orientation of the carried antennas, for example according to the capacities and the number of these and the missions to be performed.

Based on the present description and the detailed embodiments, other implementations are possible and within the reach of a person skilled in the art while remaining within the scope of the present invention. In particular, specified elements could be inverted or associated in any manner remaining within the scope of the present disclosure. Also, elements of different implementations could be combined, completed, modified or suppressed so as to produce other implementations. All of these possibilities are covered by the present disclosure.

1. A method for arranging a set of antennas adapted to emit or receive in a radio frequency range in an existing aerodyne implemented either during an initial installation operation, or in a subsequent maintenance or upgrade operation, said method comprising the steps of:
dismounting at least one component of a structural element external to the airfoil surface of the existing aerodyne, the component being substantially transparent to the radio frequency range;
setting up the antenna set in an area cleared by the dismount of step;
adjusting an electronic and electrical harness connecting the antenna set to a radio communication system and to an electrical power supply inside the fuselage;
reforming the outer structural element so as to cover the antenna set in place.

2. The method according to claim 1, wherein the dismounted at least one component is a cowl of the aerodyne.

3. The method according to claim 1, wherein the set-up step comprises a step of fastening an antenna support structure on the fuselage.

4. The method according to claim 1, wherein the reforming step comprises a step of remounting the dismounted at least one component.
